(19) United States
(12) Patent Application Publication
(10) Pub. No.: US 2016/0077377 A1
(43) Pub. Date: Mar. 17, 2016

(54) WIRE GRID POLARIZER, DISPLAY DEVICE INCLUDING THE SAME AND METHOD FOR FABRICATING THE SAME

(71) Applicant: Samsung Display Co., Ltd., Yongin-City (KR)

(72) Inventors: Ji Hun KIM, Asan-si (KR); Moon Jung AN, Hwaseong-si (KR); Yun Jong YEO, Seoul (KR); Hyun Min CHO, Asan-si (KR); Sang Gab KIM, Seoul (KR)

(21) Appl. No.: 14/623,728

(22) Filed: Feb. 17, 2015

(30) Foreign Application Priority Data
Sep. 12, 2014 (KR) 10-2014-0121111

(51) Int. Cl. G02F 1/1335; G02B 5/30

(52) U.S. Cl. CPC G02F 1/133536; G02B 5/3058; G02F 1/1336; G02F 2001/133548

(57) ABSTRACT

Provided is a wire grid polarizer. The wire grid polarizer includes a substrate, and a plurality of conductive wire patterns which are in parallel with each other and projected from the substrate. The plurality of conductive wire patterns includes a conductive wire pattern material in which an oxide layer is defined at an outer side surface thereof, and an oxidation resistant layer on the oxide layer at the outer side surface of the conductive wire pattern material. The oxide layer is between the oxidation resistant layer and a remainder of the conductive wire pattern material.

This application claims priority to Korean Patent Application No. 10-2014-0121111 filed on Sep. 12, 2014, and all the benefits accruing therefrom under 35 U.S.C. 119, the contents of which in its entirety are herein incorporated by reference.

### BACKGROUND

1. Field

The invention relates to a wire grid polarizer, a display device including the same and a method of fabricating the same.

2. Description of the Related Art

A parallel conductive wire array, in which conductor wires are arranged parallel to each other in order to polarize a certain light in electromagnetic waves, is generally called a wire grid or wire grid polarizer.

The wire grid structure having a cycle smaller than that of the wavelength of incident light has the characteristic that the polarized light parallel to the wire direction is reflected by the wire grid, and the polarized light perpendicular to the wire direction is transmitted through the wire grid. A wire grid polarizer is more beneficial than an absorptive polarizer in that it allows reflected polarized light to be reused.

### SUMMARY

A wire grid polarizer is formed of and/or includes a conductive material. When a conductive material is naturally oxidized to form an oxide layer, the oxide layer is formed on the surface of the conductive material and generally has a high refractive index. Further, as the refractive index of the oxide layer increases, the transmission rate of the wire grid polarizer in the visible light ray spectrum and the light extinction ratio are undesirably lowered.

The invention provides a wire grid polarizer having improved transmission rate in the visible light ray spectrum and an increased light extinction ratio, a display device including the same and a method of fabricating the same.

Additional advantages, subjects and features of the invention will be set forth in part in the description which follows and in part will become apparent to those having ordinary skill in the art upon examination of the following or may be learned from practice of the invention.

In accordance with an exemplary embodiment of the invention, there is provided a wire grid polarizer including a substrate, and a plurality of conductive wire patterns in parallel with each other and projected from the substrate. The plurality of conductive wire patterns includes a conductive wire pattern material in which an oxide layer is defined at an outer side surface thereof, and an oxidation resistant layer on the oxide layer at the outer side surface of the conductive wire pattern material. The oxide layer is between the oxidation resistant layer and a remainder of the conductive wire pattern material.

In accordance with another exemplary embodiment of the invention, there is provided a wire grid polarizer including a substrate, and a plurality of conductive wire patterns in parallel with each other and projected from the substrate. The plurality of conductive wire patterns includes a conductive wire pattern material in which an oxide layer is defined at an outer side surface thereof, and an oxidation resistant layer on the outer side surface of the conductive wire pattern material at which the oxide layer is defined. A thickness of the oxide layer defined in the conductive wire pattern material, in a direction normal to the conductive wire pattern material outer side surface at which the oxide layer is defined, is greater than 0 nanometer and is equal to or smaller than about 2.5 nanometers.

In accordance with another exemplary embodiment of the invention, there is provided a liquid crystal device including a backlight unit which generates and emits light, a liquid crystal panel which is disposed on the backlight unit, and a wire grid polarizer which is arranged on an upper part, a lower part, or both the upper part and the lower part of the liquid crystal panel. The liquid crystal panel includes a lower display substrate, a liquid crystal layer and an upper display substrate.

In accordance with another exemplary embodiment of the invention, there is provided a method of fabricating a wire grid polarizer, the method including forming a conductive wire pattern on a substrate. The forming a conductive wire pattern on a substrate includes forming a conductive wire pattern material in which an oxide layer is defined at an outer surface thereof, and forming an oxidation resistant layer on the outer side surface of the conductive wire pattern material at which the oxide layer is defined. The oxide layer at the outer side surface of the conductive wire pattern material is not exposed outside the conductive wire pattern after the forming the conductive wire pattern.

According to one or more exemplary embodiment of the invention, a wire grid polarizer has improved transmission rate in the visible light ray spectrum and an increased light extinction ratio.

The exemplary embodiments and effects according to the invention are not limited to the contents as exemplified above, but further various effects are included within the scope of the invention.

### BRIEF DESCRIPTION OF THE DRAWINGS

The above and other features and advantages of the invention will become more apparent by describing in detail exemplary embodiments thereof with reference to the attached drawings in which:

FIG. 1 is a cross-sectional view of an exemplary embodiment of a wire grid polarizer according to the invention.

FIG. 2 is an enlarged cross-sectional view of an exemplary embodiment of portion A in FIG. 1.

FIG. 3 is an enlarged cross-sectional view of another exemplary embodiment of portion A in FIG. 1.

FIG. 4 is a cross-sectional view of another exemplary embodiment of a wire grid polarizer according to the invention.

FIG. 5 is an enlarged cross-sectional view of an exemplary embodiment of portion A′ in FIG. 4.

FIG. 6 is an enlarged cross-sectional view of another exemplary embodiment of portion A′ in FIG. 4.

FIG. 7 is a cross-sectional view of an exemplary embodiment of a liquid crystal display device according to the invention.

FIGS. 8 to 17 are cross-sectional views of an exemplary embodiment of a method of fabricating a wire grid polarizer according to the invention.

FIGS. 18 to 26 are cross-sectional views of another exemplary embodiment of a method of fabricating a wire grid polarizer according to the invention.

### DETAILED DESCRIPTION

Advantages and features of the invention and methods of accomplishing the same may be understood more readily by reference to the following detailed description of exemplary embodiments and the accompanying drawings. The invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the invention will only be defined by the appended claims. Like reference numerals refer to like elements throughout the specification.

The terminology used herein is for the purpose of describing particular exemplary embodiments only and is not intended to be limiting of the invention. As used herein, the singular forms “a,” “an” and “the” are intended to include the plural forms as well, unless the context clearly indicates otherwise.

It will be further understood that the terms “comprises” and/or “comprising,” when used in this specification, specify the presence of stated features, integers, steps, operations, elements and/or components, but do not preclude the presence or addition of one or more other features, integers, steps, operations, elements, components and/or groups thereof.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” other elements or features would then be oriented “upper” the other elements or features. Thus, the exemplary term “lower” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Exemplary embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, exemplary embodiments of the invention will be described with reference to the accompanying drawings.

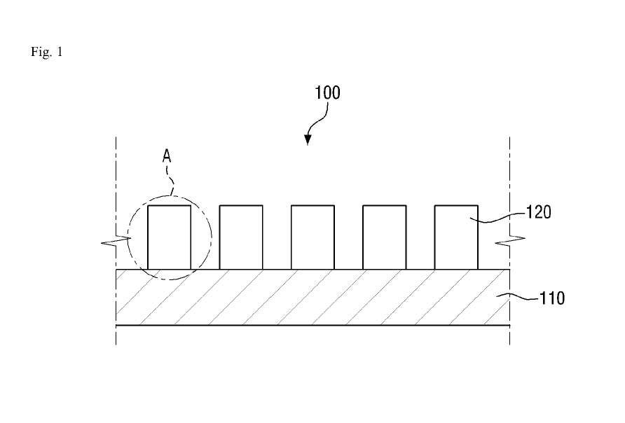

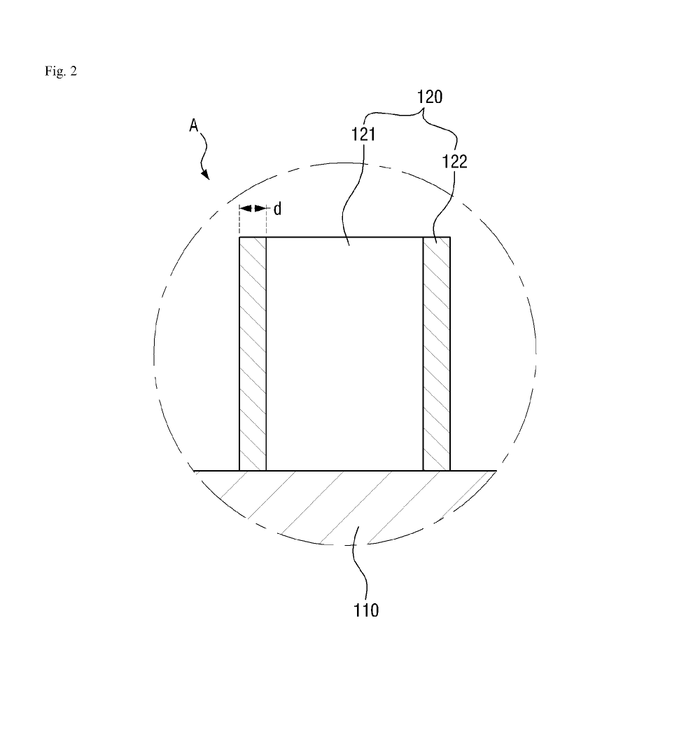

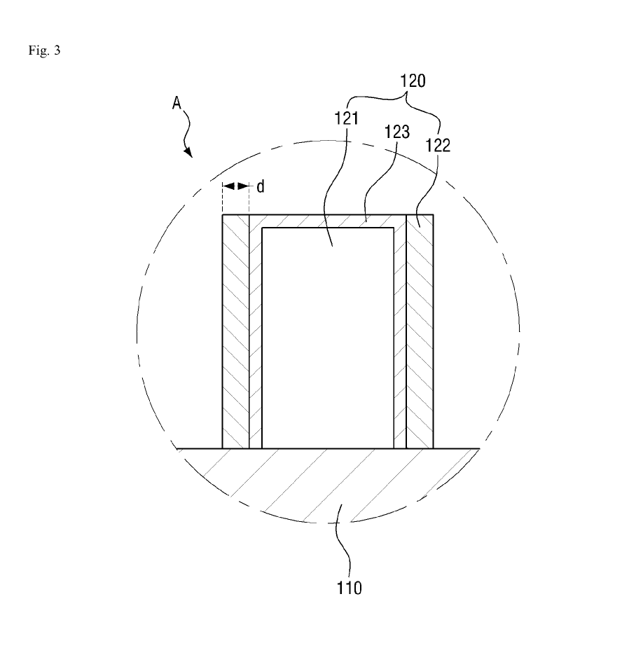

FIG. 1 is a cross-sectional view of an exemplary embodiment of a wire grid polarizer according to the invention, FIG. 2 is an enlarged cross-sectional view of an exemplary embodiment of portion A in FIG. 1, and FIG. 3 is an enlarged cross-sectional view of another exemplary embodiment of portion A in FIG. 1.

First, referring to FIG. 1, a wire grid polarizer 100 includes a substrate 110, and a plurality of conductive wire patterns 120 which is elongated in parallel with each other and projected from the substrate 110. While reference numeral 120 is indicated for a single conductive wire pattern in FIG. 1, the reference numeral 120 may also be used to refer to more than one conductive wire pattern.

The material of the substrate 110 may be appropriately selected as a material which allows transmission of visible light rays according to the usage or process thereof. For example, various polymers such as glass, quartz, acryl, triacetylcellulose (“TAC”), cyclic olefin copolymer (“COC”), cyclic olefin polymer (“COP”), polycarbonate (“PC”), polyethylenenaphthalate (“PEN”), and polyethersulfone (“PES”) may be used, but the invention is not limited thereto. The substrate 110 may also include an optical film material having flexibility.

The plurality of conductive wire patterns 120 may be arranged to be elongated in parallel with each other on the substrate 110 with a certain cycle. As the cycle of the conductive wire patterns 120 gets shorter compared to the wavelength of incident light thereto, the extinction ratio of the polarized light may become higher. However, as the cycle gets shorter, fabrication of the conductive wire patterns 120 becomes more difficult.

The visible light ray area or spectrum is generally between about 380 nanometers (nm) and about 780 nm. In order for the wire grid polarizer to have a high extinction ratio for three primary colors of light of red, green and blue (R, G, B), the wire grid polarizer has at least a cycle of 200 nm or less. However, the wire grid polarizer may also have a cycle of 120 nm or less to have polarized light performance which is equal to or higher than the performance of the existing or conventional polarizers.

A conductive wire pattern 120 may include a conductive material. In an exemplary embodiment, the conductive wire pattern 120 may include metal, such as one selected from aluminum (Al), chromium (Cr), silver (Ag), copper (Cu), nickel (Ni), cobalt (Co) and molybdenum (Mo), or an alloy thereof, but the material of the conductive wire pattern 120 is not limited thereto.

Referring to FIG. 1, a thickness of a conductive wire pattern 120 is taken perpendicular to the substrate 110, while a width of the conductive wire pattern 120 is taken in a horizontal direction parallel to the substrate 110. The width of the conductive wire pattern 120 may be between about 10 nm and about 200 nm, but the invention is not limited thereto. Further, the thickness of the conductive wire pattern 120 may between about 10 nm and about 500 nm, but the invention is not limited thereto.

Referring to FIG. 2, an exemplary embodiment of the conductive wire pattern 120 may include a conductive wire pattern material 121, and an oxidation resistant layer 122 which is disposed on or at a side of the conductive wire pattern material 121. The conductive wire pattern material 121 may define a base member of the conductive wire pattern 120. In an exemplary embodiment of a method of fabricating the conductive wire pattern 120, the conductive wire pattern material 121 and the oxidation resistant layer 122 may be formed without passing through the oxide layer of the conductive wire pattern material 121.

The expression “without passing through the oxide layer” may include an exemplary embodiment in which there is no oxide layer (e.g., oxide layer excluded from the conductive wire pattern 120). The expression “without passing through the oxide layer” may also include an exemplary embodiment in which there is an oxide layer at or in some portion of the surface of the conductive wire pattern material 121. Where there is an oxide layer at or in a first portion less than an entirety of the surface of the conductive wire pattern material 121, there is a second portion of the surface thereof different from the first portion where there is no oxide layer so that the conductive wire pattern material 121 and the oxidation resistant layer 122 directly contact each other.

A thickness d of the oxidation resistant layer 122 is taken in a direction normal to the surface of the conductive wire pattern material 121. The thickness d of the oxidation resistant layer 122 may be between about 2 nm and about 8 nm. When the thickness d of the oxidation resistant layer 122 is 2 nm or greater, the oxidation of the conductive wire pattern material 121 may be reduced or effectively prevented, and when the thickness d is 8 nm or less, the polarization performance may not be deteriorated.

A material for reducing or effectively preventing contact between oxygen or water in the air and the conductive wire pattern material 121 may be used as the oxidation resistant layer 122. In an exemplary embodiment, for example, fluorocarbon polymer may be used in the oxidation resistant layer 122. In an exemplary embodiment of a method of fabricating a wire grid polarizer, forming the oxidation resistant layer 122 includes plasma-depositing and polymerizing fluorocarbon gas, but the invention is not limited thereto.

When the fluorocarbon polymer is used in the oxidation resistant layer 122, an outer surface of the conductive wire patterns 120 including the oxidation resistant layer 122 becomes hydrophobic, and thus even when applying a protective layer (not shown) to the conductive wire patterns 120, a space between adjacent conductive wire patterns 120 may be easily maintained in a hollow state (e.g., absent or void material of the conductive wire patterns 120.

Referring to FIG. 3, another exemplary embodiment of the conductive wire pattern 120 includes a conductive wire pattern material 121, an oxide layer 123 of the conductive wire pattern material 121, and the oxidation resistant layer 122 which is disposed on a side surface of the conductive wire pattern 120. The conductive wire pattern material 121, and an oxide layer 123 of the conductive wire pattern material 121 may collectively be referred to as a conductive wire pattern material member. Reference numeral 121 in FIG. 3 may indicate a base portion of the collective conductive wire pattern material member.

The oxide layer 123 of the conductive wire pattern material 121 may be disposed between a base portion 121 of the conductive wire pattern material member and the oxidation resistant layer 122, in a width direction of the conductive wire pattern 120.

The oxide layer 123 of the conductive wire pattern material 121 may be disposed extended throughout an entirety of an outer surface of the conductive wire pattern material 121, but the invention is not limited thereto. FIG. 3 shows the oxide layer 123 disposed at an upper part of the conductive wire pattern 120, but the invention is not limited thereto. In an exemplary embodiment, the oxide layer 123 of the conductive wire pattern material 121 may not be included (e.g., may be excluded) in an upper part of the conductive wire pattern 120, such that the oxide layer 123 is disposed at only side surfaces of the conductive wire pattern 120. In an exemplary embodiment of a method of fabricating the conductive wire pattern 120, a portion of the oxide layer 123 initially formed at the upper part of the conductive wire pattern 120 may be etched to be removed in the process of forming the oxidation resistant layer 122.

A thickness of the oxide layer 123 is taken in a direction normal to the surface of the base portion 121 of the conductive wire pattern material member. The thickness of the oxide layer 123 of the conductive wire pattern material 121 may be between 0 nm and 2.5 nm. In an exemplary embodiment, the thickness of the oxide layer 123 of the conductive wire pattern material 121 may be less than about 2 nm.

Other components of FIG. 3 are the same as or correspond to the components of FIG. 2, and thus the redundant description will be omitted here.

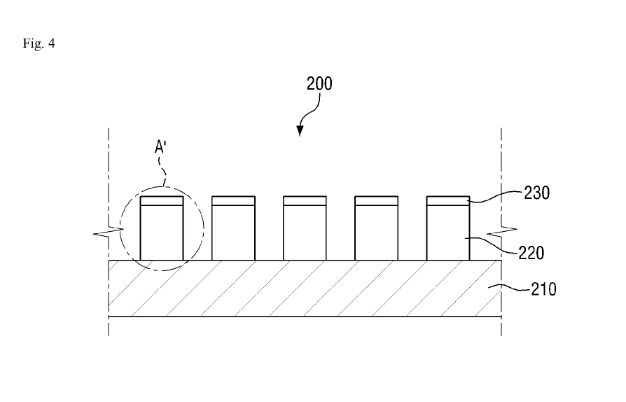

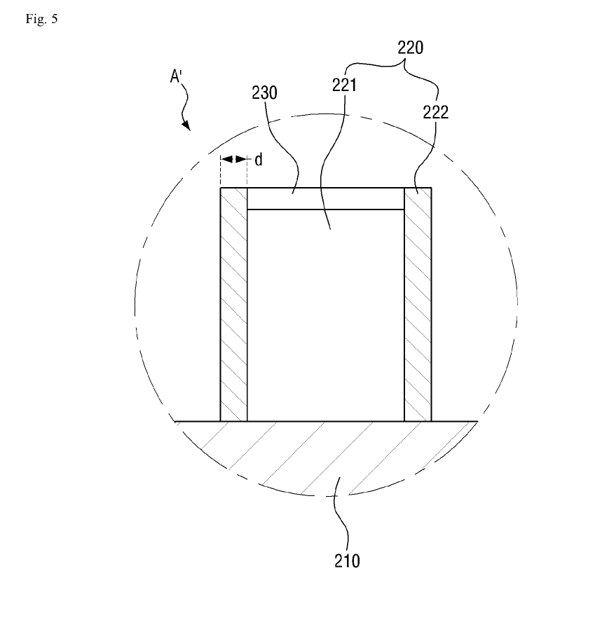

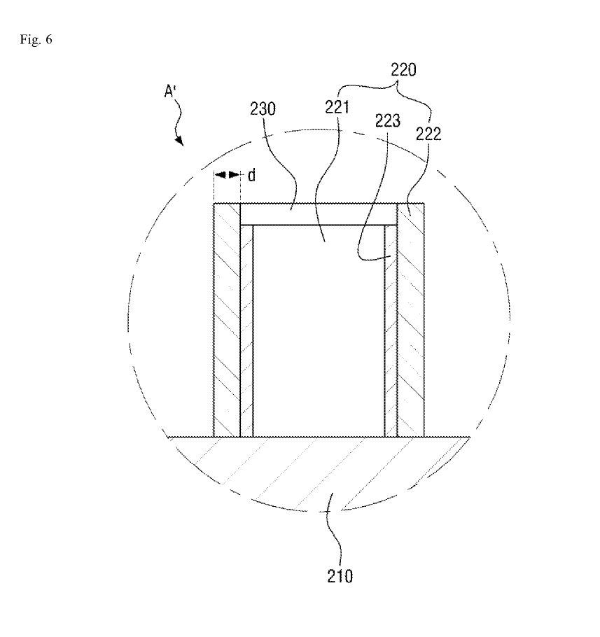

FIG. 4 is a cross-sectional view of another exemplary embodiment of a wire grid polarizer according to the invention, FIG. 5 is an enlarged cross-sectional view of an exemplary embodiment of portion A′ in FIG. 4, and FIG. 6 is an enlarged cross-sectional view of another exemplary embodiment of portion A′ in FIG. 4.

First, referring to FIG. 4, a wire grid polarizer 200 includes a substrate 210, a plurality of conductive wire patterns 220 which is elongated parallel with each other and projected from the substrate 210, and non-conductive patterns 230 which are respectively disposed on the conductive wire patterns 220. While reference numerals 220 and 230 are indicated for a single conductive wire pattern and single non-conductive pattern in FIG. 4, the reference numerals 220 and 230 may also be used to refer to more than one conductive wire pattern and more than one non-conductive wire pattern, respectively.

The non-conductive wire patterns 230 may be disposed on the conductive wire patterns 220. Referring to FIG. 4, a thickness of the non-conductive wire pattern 230 is taken perpendicular to the substrate 110, while a width of the non-conductive wire pattern 230 is taken in a horizontal direction parallel to the substrate 110. The width of the conductive wire patterns 230 may be the same as or smaller than that of the width of the conductive wire patterns 220, and the thickness of the non-conductive wire patterns 230 may be between about 10 nm and about 300 nm, but the invention is not limited thereto.

The shape of the cross-section of the non-conductive wire patterns 230 may be one of a quadrangle, a triangle, a semicircle and a semiellipse, but the invention is not limited thereto. Various shapes may be compositively formed from the afore-mentioned shapes, according to the desired thickness and cross-section of the non-conductive wire patterns 230.

The non-conductive wire patterns 230 may include a non-conductive and transparent material. In an exemplary embodiment, the non-conductive wire pattern 230 may include one of a polymer, an oxide and a nitride, and a silicon oxide and a silicon nitride may be a more specific example, but the invention is not limited thereto.

Other components of FIG. 4 are the same as or correspond to the components of FIG. 1, and thus the redundant description will be omitted.

Referring to FIG. 5, an exemplary embodiment of the conductive wire pattern 220 may include a conductive wire pattern material 221, and an oxidation resistant layer 222 which is disposed on a side surface of the conductive wire pattern material 221. The conductive wire pattern material 221 may define a base member of the conductive wire pattern 220. In an exemplary embodiment of a method of fabricating the conductive wire pattern 120, the conductive wire pattern material 221 and the oxidation resistant layer 222 may be formed without passing through the oxide layer of the conductive wire pattern material 221. Further, the oxidation resistant layer 222 may be extended up to the side surface of the non-conductive wire pattern 230 and be extended to be coplanar with an upper surface of the non-conductive wire pattern 230.

The expression “without passing through the oxide layer” may include an exemplary embodiment in which there is no oxide layer on the entirety of the surface of the conductive wire pattern material 221 (e.g., oxide layer excluded from the conductive wire pattern 220). The expression “without passing through the oxide layer” may also include an exemplary embodiment in which there is an oxide layer at or in some portion of the surface of the conductive wire pattern material 221. Where there is an oxide layer at or in a first portion less than an entirety of the surface of the conductive wire pattern material 221, there is a second portion of the surface thereof different from the first portion where there is no oxide layer so that the conductive wire pattern material 221 and the oxidation resistant layer 222 directly contact each other.

Other components of FIG. 5 are the same as or correspond to the components of FIG. 2, and thus the redundant description will be omitted here.

Referring to FIG. 6, another exemplary embodiment of the conductive wire pattern 220 includes a conductive wire pattern material 221, an oxide layer 223 of the conductive wire pattern material 221, and the oxidation resistant layer 222 which is disposed on a side surface of the conductive wire pattern 220. The conductive wire pattern material 221, and the oxide layer 223 of the conductive wire pattern material 221 may collectively be referred to as a conductive wire pattern material member. Reference numeral 221 in FIG. 6 may indicate a base portion of the collective conductive wire pattern material member.

In an exemplary embodiment of a method of fabricating the conductive wire pattern 220, the conductive wire pattern material 221 and the oxidation resistant layer 222 may be formed such that the oxide layer 223 of the conductive wire pattern material is between the base portion 221 and the oxidation resistant layer 222.

The oxide layer 223 of the conductive wire pattern material 221 may be disposed extended on a side surface of the base portion 221 of the conductive wire pattern material member, but the invention is not limited thereto. An oxide layer may be disposed to be extended even past a boundary at which the base portion 221 of the conductive wire pattern material member meets the non-conductive wire patterns 230.

Further, in an exemplary embodiment of a method of fabricating the conductive wire pattern 220, a portion of the non-conductive wire patterns 230 may be etched to be removed in the process of forming the oxidation resistant film 222 so that only a portion of the non-conductive wire patterns 230 overlapping the collective conductive wire pattern material member may remain.

Other components of FIG. 6 are the same as or correspond to the components of FIG. 3, and thus the redundant description will be omitted.

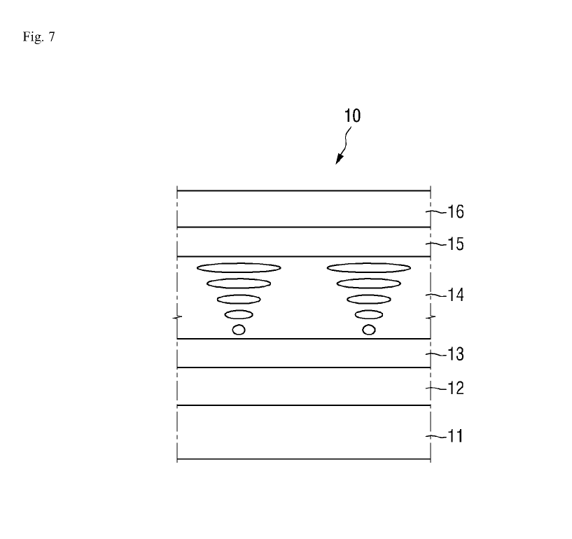

FIG. 7 is a sectional view of an exemplary embodiment of a liquid crystal display device according to the invention.

Referring to FIG. 7 along with FIGS. 1 to 6, the liquid crystal display device 10 includes a backlight unit 11 which generates and emits light, a liquid crystal panel 13, 14, and 15 which is disposed on the backlight unit 11, and an upper polarizing plate 16 and a lower polarizing plate 12 which are disposed on the upper part and the lower part of the liquid crystal panel 13, 14, and 15. The liquid crystal panel includes a lower display substrate 13, a liquid crystal layer 14, and an upper display substrate 15

When two polarizing plates 12 and 16 are placed at the upper part and the lower part of the liquid crystal panel 13, 14, and 15, the transmission axes of the upper polarizing plate 16 and the lower polarizing plate 12 may be perpendicular to each other or in parallel to each other.

FIG. 7 illustrates that the upper polarizing plate 16 and the lower polarizing plate 12 are included in the upper part and the lower part of the liquid crystal panel 13, 14, and 15, respectively, but the upper polarizing plate 16 may be omitted in an alternative exemplary embodiment.

The backlight unit 11 is not specifically illustrated, but the backlight unit 11 may further include a light guide plate (“LGP”), a light source unit, a reflective member and an optical sheet, for example.

The LGP is configured to change a path of light generated in the light source unit and transmitted to the side of the liquid crystal layer 14. The LGP may include a light input surface through which is transmitted incident light generated in the light source unit, and a light output surface through which light is directed toward the liquid crystal layer 14. The LGP may include a material having a constant reflective index such as polymethylmethacrylate (“PMMA”) or PC, but the invention is not limited thereto.

The light incident to one side or both of opposing sides of the LGP has an angle within a threshold angle of the LGP, and thus the light is transferred to the inside of the LGP. Further, when the light is incident upon the lower surface of the LGP, the angle of light becomes beyond the threshold angle, and thus light is not emitted to the outside of the LGP, but the light is indiscriminately delivered to the inside of the LGP to be recycled.

A dispersed pattern may be disposed on one of the upper surface and the lower surface of the LGP, e.g., the lower surface facing the output light surface so that the light may be emitted to the upper part of the LGP. That is, a dispersed pattern may be printed on one surface of the LGP, for example, by including ink, so that light transmitted from the inside of the LGP to be emitted to the upper part of the LGP. Such a dispersed pattern may be formed by printing by ink, but the invention is not limited thereto. Minute grooves or projections may be defined in or on the LGP and other modified methods may also be used to form the dispersed pattern in an alternative exemplary embodiment.

A reflective member may be further provided between the LGP and the lower part of a lower receiving member of the liquid crystal display device 10. The reflective member reflects the light emitted toward the opposite side of the LGP facing the lower surface of the LGP, e.g., the output light surface, so as to re-supply light to the LGP. The reflective member may be of a film form, but the invention is not limited thereto.

The light source unit may be disposed to face the input light surface of the LGP. The number of the light source units may be appropriately changed as necessary. In an exemplary embodiment, for example, one single light source unit may be provided at only one of the side surfaces of the LGP, and three individual light source units may be provided to respectively correspond to the three or more side surfaces among four side surfaces of the LGP. Further, a plurality of light source units which are arranged to correspond to one single side surface of the LGP may be possible. Likewise, the side light scheme (e.g., edge illumination), which is a scheme in which the light source is positioned at the side surface of the LGP, has been illustrated as an example, but there are a right under scheme (e.g., direct illumination), a surface light source scheme, etc.

The light source may be a white light emitting diode (“LED”) which emits white light, or may be a plurality of LEDs which emits light of respective R, G and B colors. When a plurality of light sources are implemented as an LED which emits light of respective R, G, and B colors, white light by color mixture may be implemented by turning on all LEDs at one time.

The lower display substrate 13 may be a thin film transistor (“TFT”) substrate. Though not specifically illustrated in FIG. 7, a TFT which is composed of a gate electrode, a gate insulating layer, a semiconductor layer, a resistant contact layer and a source/drain electrode, and a pixel electrode which is an electric field generation electrode including a transparent conductive oxide such as indium tin oxide (“ITO”) or indium zinc oxide (“IZO”), may be included in the lower display substrate 13.

The upper display substrate 15 may be a color filter (“CF”) substrate. Though not specifically illustrated in FIG. 7, a black matrix configured to reduce or effectively prevent leakage of light, a CF of R, G and B colors, and a common electrode which is an electric field generation electrode including a transparent conductive oxide such as ITO and IZO, may be included in the upper display substrate 15.

A plastic substrate may be used in the lower display substrate 13 and/or the upper display substrate 15, and may include polyethylene terephthalate (“PET”), PC, polyimide (“PI”), PEN, PES, polyarylate (“PAR”) and COC, but the invention is not limited thereto. Further, the lower display substrate 13 and the upper display substrate 15 may include a flexible material.

The liquid crystal layer 14 rotates the polarization axis of the incident light and is directed toward a constant direction, and is disposed between the upper display substrate 15 and the lower display substrate 13. The liquid crystal layer 14 may be employed for a twisted nematic (“TN”) mode, a vertical alignment (“VA”) mode, and horizontal alignment mode such as an in-plane switching (“IPS”) or fringe field switching (“FFS”) mode.

The lower polarizing plate 12 and the upper polarizing plate 16 may be any of the exemplary embodiments of a wire grid polarizing plate which is illustrated above with reference to FIGS. 1 to 6.

As a display device, the liquid crystal display device was used as an example in the above exemplary embodiment, but an organic light emitting display device without including a separate light source and a light guide plate, or a plasma display device, may also be used as the display device according to the invention.

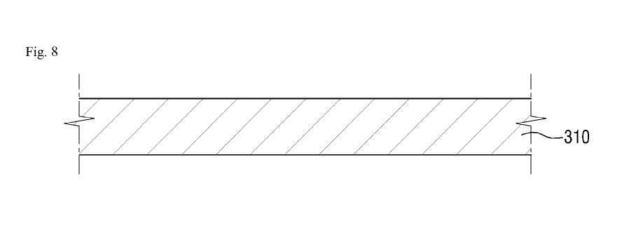

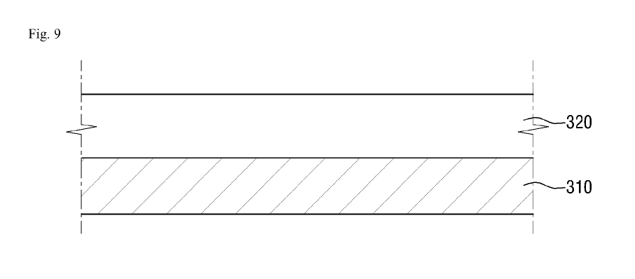

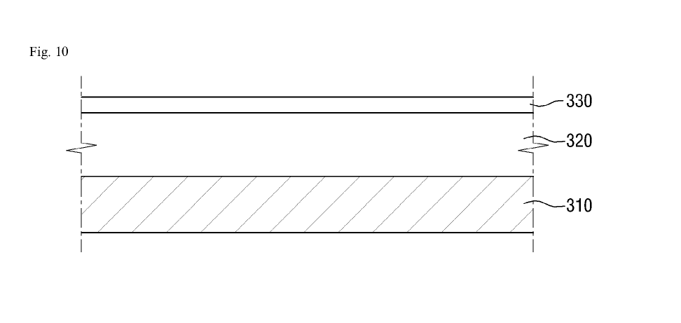

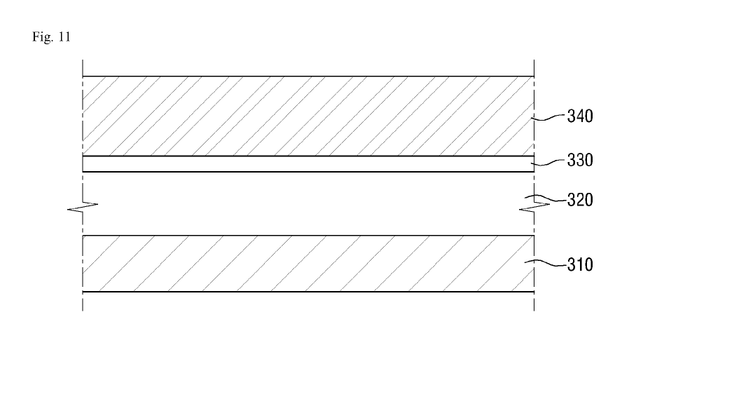

FIGS. 8 to 17 are cross-sectional views of an exemplary embodiment of a method of fabricating a wire grid polarizer according to the invention.

Referring to FIGS. 8-11, a conductive wire pattern layer 320, a non-conductive wire pattern layer 330 and a photoresist layer 340 may be disposed on a substrate 310.

The conductive wire pattern layer 320 and the non-conductive wire pattern layer 330 may be formed by using a general sputtering method, a chemical vapor deposition method, an evaporation method, etc., but the invention is not limited thereto.

The photoresist layer 340 may be formed by using spin coating, but the invention is not limited thereto.

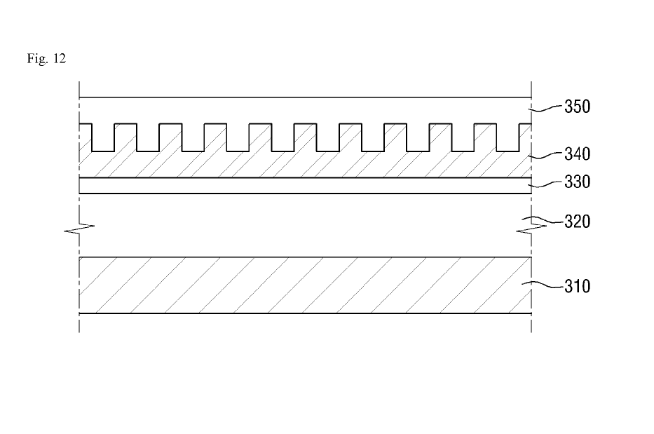

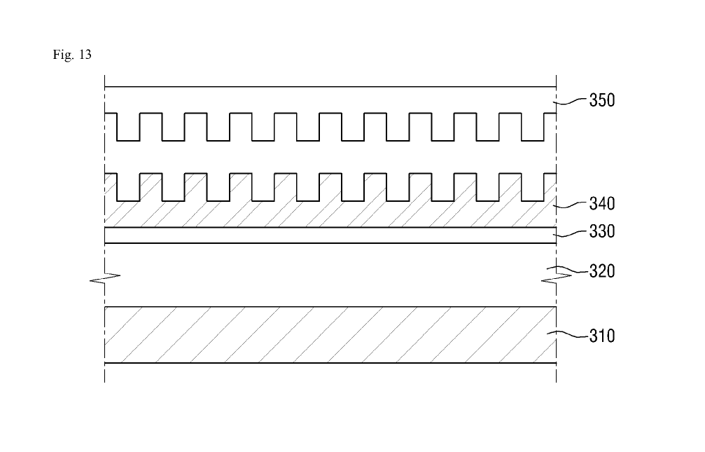

Referring to FIGS. 12 and 13, the photoresist layer 340 may be patterned such as with an imprint mold 350 where a pattern of the imprint mold 350 is transferred to the disposed photoresist layer 340 and then the imprint mold 350 may be removed, but the invention is not limited thereto.

In an exemplary embodiment, for example, patterning of the photoresist layer 340 may be performed through a patterned light exposed to the photoresist layer 240, by applying a mask to the photoresist layer 340.

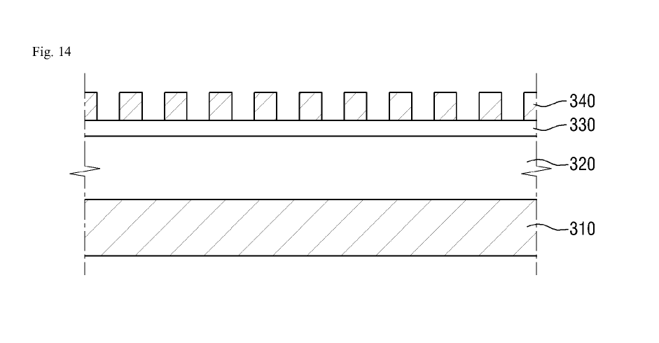

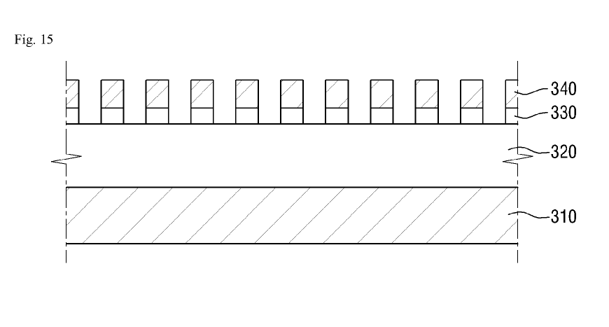

Referring to FIG. 14, a portion of the patterned photoresist layer 340 is removed, such as where the imprint mold 350 pattern is transferred to the photoresist layer 340, such that only the patterned photoresist layer 340 remains. The non-conductive wire pattern layer 330 is etched using the patterned photoresist layer 340 as a mask, referring to FIG. 15. The patterned photoresist layer 340 may be removed from the etched non-conductive wire pattern layer 330, but the invention is not limited thereto.

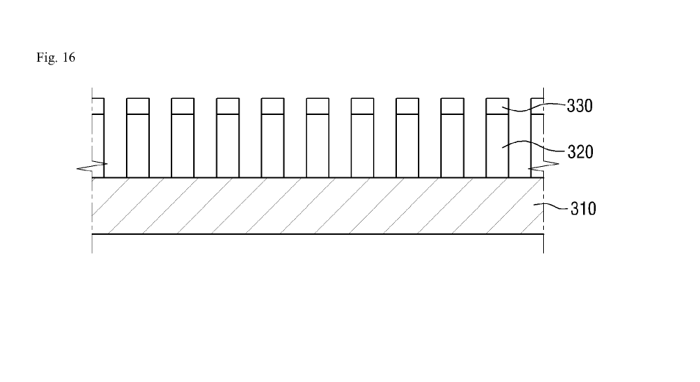

Referring to FIG. 16, the conductive wire pattern layer 320 is etched using the etched non-conductive wire pattern layer 330 as a mask, so as to be patterned. In this process, a portion of the non-conductive wire pattern layer 330 may remain at the upper part of the etched conductive wire pattern layer 320.

The etching described above may use any generally used etching process.

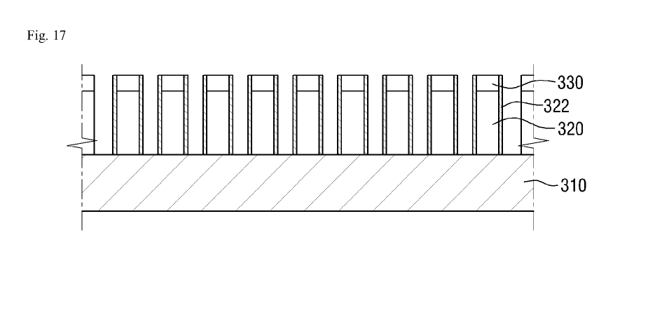

Referring to FIG. 17, after the etching of the conductive wire pattern layer 320 is completed, an oxidation resistant layer 332 including a fluorocarbon polymer at each side surface of the etched conductive wire pattern layer 320 may be formed such as by depositing the fluorocarbon gas within a vacuum chamber. When the fluorocarbon gas is used, even if a separate chlorine removing process is not performed, fluorine with reactivity higher than that of chlorine may remove remaining chlorine. In an exemplary embodiment of a method of fabricating a wire grid polarizer, forming the oxidation resistant layer 322 includes plasma-depositing and polymerizing fluorocarbon gas, but the invention is not limited thereto.

The fluorocarbon gas may be one or more selected from C4F8, CHF3, CH2F2, CF4, and C2F6.

In the above described method of forming a conductive wire pattern on a substrate, a conductive wire pattern material in which an oxide layer is defined at an outer surface thereof is firstly formed, and an oxidation resistant layer is formed on a side surface of the conductive wire pattern material in which the oxide layer is defined. A such, the oxide layer at the outer surface of the conductive wire pattern material is not exposed outside the conductive wire pattern after the forming the conductive wire pattern. For example, the oxidation resistant layer and the non-conductive pattern cover the conductive wire pattern material in which the oxide layer is defined such that the oxide layer at the outer surface of the conductive wire pattern material is not exposed outside the conductive wire pattern after the forming the conductive wire pattern.

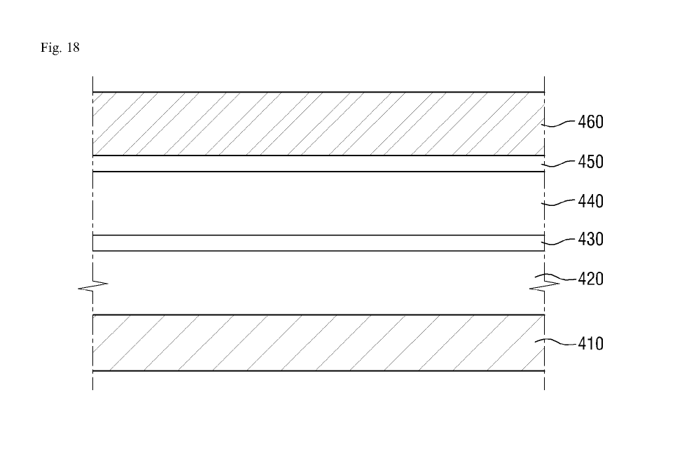

FIGS. 18 to 26 are cross-sectional views of another exemplary embodiment of a method of fabricating a wire grid polarizer according to the invention.

Referring to FIG. 18, a conductive wire pattern layer 420, a non-conductive wire pattern layer 430, an amorphous carbon layer 440, an insulating layer 450, and a photoresist layer 460 may be disposed on a substrate 410.

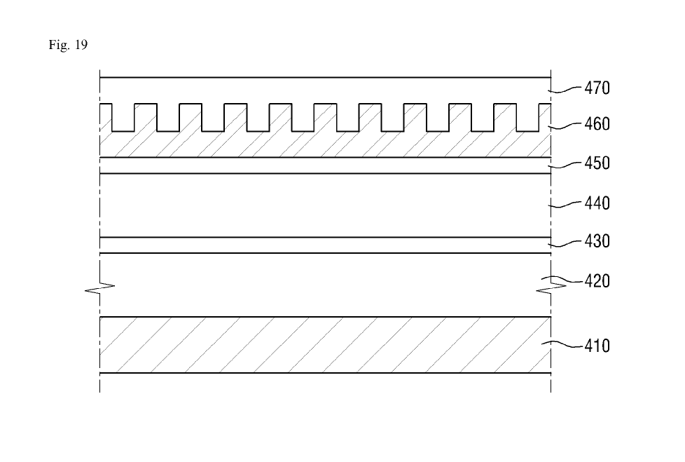

Referring to FIG. 19, the photoresist layer 460 may be patterned such as with an imprint mold 470 where a pattern of the imprint mold 470 is transferred to the disposed photoresist layer 460.

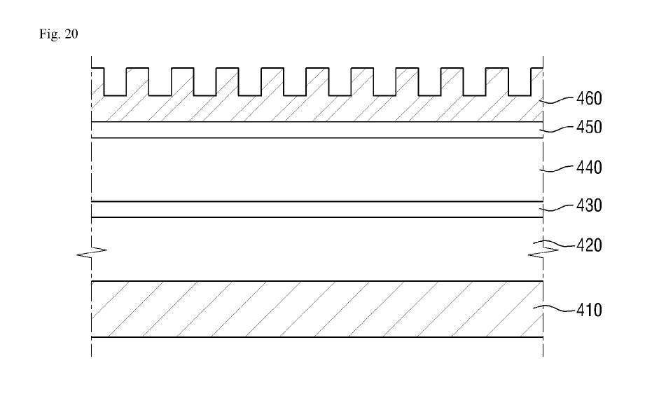

Referring to FIG. 20, after patterning the photoresist layer 460 with an imprint mold 470 where the pattern is formed on the disposed photoresist layer 460, the imprint mold 470 may be removed, but the invention is not limited thereto.

In an exemplary embodiment, for example, the patterning of the photoresist layer 460 may be performed through a patterned light exposed to the photoresist layer 460 by applying a mask to the photoresist layer 460.

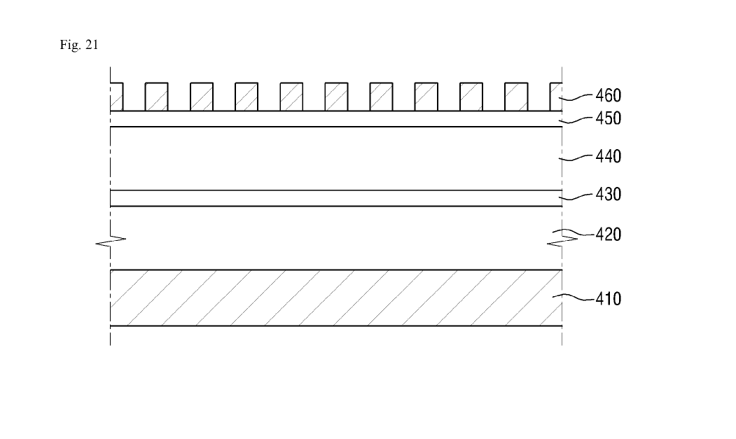

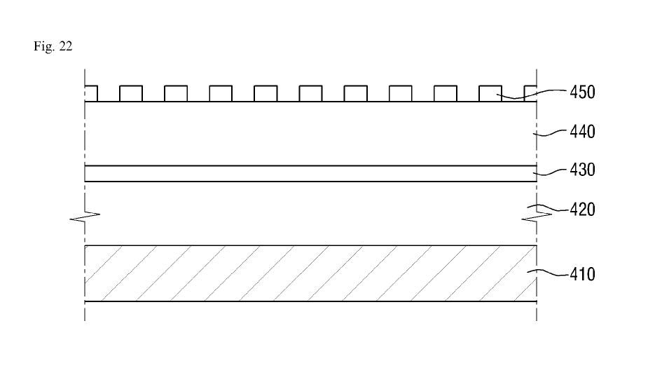

Referring to FIG. 21, a portion of the patterned photoresist layer 460 may be removed such as where the imprint mold 470 is transferred to the pattern-formed photoresist layer 460, such that only the patterned photoresist layer 460 remains. The insulating layer 450 may be etched using the patterned photoresist layer 460 as a mask, referring to FIG. 22 so as to be patterned. The patterned photoresist layer 460 may be removed from the etched insulating layer 450, but the invention is not limited thereto.

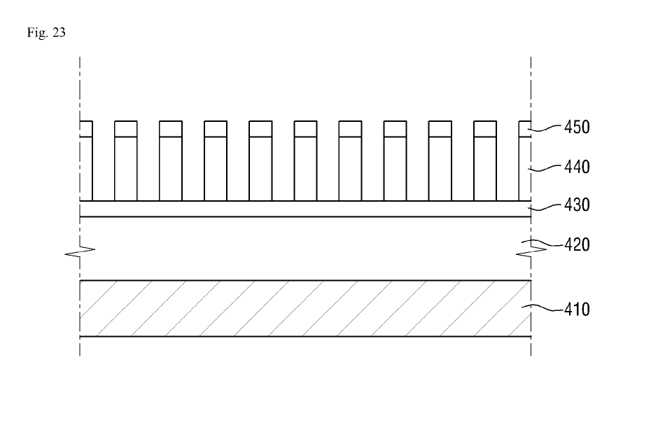

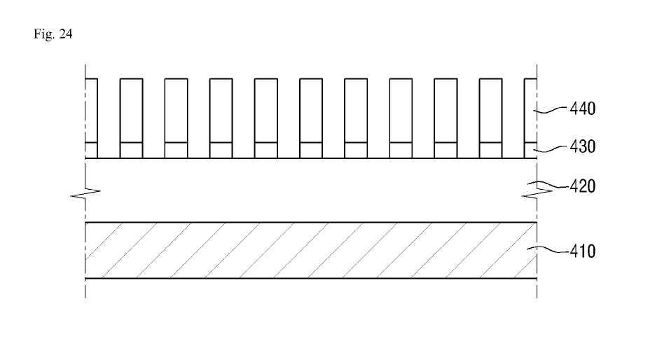

Referring to FIG. 23, the amorphous carbon layer 440 may be etched by using the patterned insulating layer 450 as a mask so as to be patterned. Referring to FIG. 24, the non-conductive wire pattern layer 430 may be etched by using the patterned amorphous carbon layer 440 as a mask so as to be patterned. The patterned insulating layer 450 may be removed from the patterned amorphous carbon layer 440, but the invention is not limited thereto.

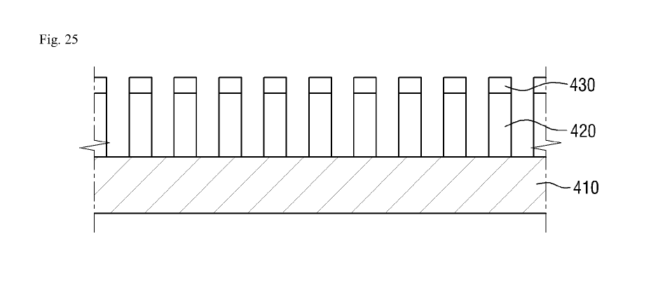

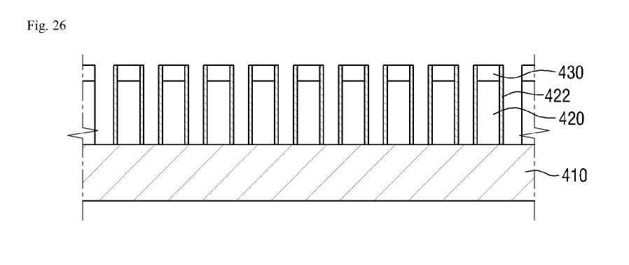

Etching of the conductive wire pattern layer 420 and forming of the oxidation resistant layer 422 in FIGS. 25 and 26 is substantially the same as the etching of the conductive wire pattern layer 320 and the forming of the oxidation resistant layer 332 in FIGS. 16 and 17, respectively, and thus the redundant description will be omitted here.

When operations of FIGS. 18 to 26 are used, the stacking process may be disadvantageous, but they may be used from the perspective of etching the non-conductive wire pattern layer 430 to be thicker as compared to the processes described with reference to FIGS. 8 to 17.

Other components of FIGS. 18 to 26 are the same as or correspond to the components of FIGS. 8 to 17, and thus the redundant description will be omitted here.

In the above described method of forming a conductive wire pattern on a substrate, a conductive wire pattern material in which an oxide layer is defined at an outer surface thereof is firstly formed, and an oxidation resistant layer is formed on a side surface of the conductive wire pattern material in which the oxide layer is defined. A such, the oxide layer at the outer surface of the conductive wire pattern material is not exposed outside the conductive wire pattern after the forming the conductive wire pattern. For example, the oxidation resistant layer and the non-conductive pattern cover the conductive wire pattern material in which the oxide layer is defined such that the oxide layer at the outer surface of the conductive wire pattern material is not exposed outside the conductive wire pattern after the forming the conductive wire pattern.

Although exemplary embodiments of the invention have been described for illustrative purposes, those skilled in the art will appreciate that various modifications, additions and substitutions are possible, without departing from the scope and spirit of the invention as disclosed in the accompanying claims.

What is claimed is:

1. A wire grid polarizer comprising:
a substrate; and
a plurality of conductive wire patterns in parallel with each other and projected from the substrate,
the plurality of conductive wire patterns comprising:
a conductive wire pattern material in which an oxide layer is defined at an outer side surface thereof, and
an oxidation resistant layer on the oxide layer at the outer side surface of the conductive wire pattern material,
wherein the oxide layer is between the oxidation resistant layer and a remainder of the conductive wire pattern material.

2. The wire grid polarizer of claim 1, wherein the oxidation resistant layer is disposed at both of opposing side surfaces of the conductive wire pattern material in which the oxide layer is defined.

3. The wire grid polarizer of claim 1, further comprising:
a plurality of non-conductive wire patterns respectively on the conductive wire patterns.

4. The wire grid polarizer of claim 3, wherein the non-conductive wire patterns comprise one or more selected from silicon oxide and silicon nitride.

5. The wire grid polarizer of claim 1, wherein the conductive wire patterns comprise one metal selected from aluminum (Al), chromium (Cr), silver (Ag), cooper (Cu), nickel (Ni), cobalt (Co) and molybdenum (Mo), and an alloy thereof.

6. The wire grid polarizer of claim 1, wherein a thickness of the oxidation resistant layer in a direction normal to the conductive wire pattern material outer side surface at which the oxide layer is defined, is between about 2 nanometers and about 8 nanometers.

7. The wire grid polarizer of claim 1, wherein the oxidation resistant layer comprises a fluorocarbon polymer.

8. A wire grid polarizer comprising:
a substrate; and
a plurality of conductive wire patterns in parallel with each other and projected from the substrate,
the plurality of conductive wire patterns comprising:
a conductive wire pattern material in which an oxide layer is defined at an outer side surface thereof, and
an oxidation resistant layer on the outer side surface of the conductive wire pattern material at which the oxide layer is defined,
wherein a thickness of the oxide layer defined in the conductive wire pattern material, in a direction normal to the conductive wire pattern material outer side surface at which the oxide layer is defined, is greater than 0 nanometer and is equal to or smaller than about 2.5 nanometers.

9. The wire grid polarizer of claim 8, wherein the oxidation resistant layer is disposed at both of opposing side surfaces of the conductive wire pattern material in which the oxide layer is defined.

10. The wire grid polarizer of claim 8, further comprising:
a plurality of non-conductive wire patterns respectively on the conductive wire patterns.

11. The wire grid polarizer of claim 10, wherein the non-conductive wire pattern comprises one or more selected from silicon oxide and silicon nitride.

12. The wire grid polarizer of claim 8, wherein the conductive wire patterns comprise one metal selected from aluminum (Al), chromium (Cr), silver (Ag), cooper (Cu), nickel (Ni), cobalt (Co) and molybdenum (Mo), or an alloy thereof.

13. The wire grid polarizer of claim 8, wherein a thickness of the oxidation resistant layer, in the direction normal to the conductive wire pattern material side surface at which the oxide layer is defined, is between about 2 nanometers and about 8 nanometers.

14. The wire grid polarizer of claim 8, wherein the oxidation resistant layer comprises a fluorocarbon polymer.

15. A liquid crystal display device comprising:
a backlight unit which generates and emits light;
a liquid crystal panel which is disposed on the backlight unit and comprises a lower display substrate, a liquid crystal layer and an upper display substrate; and
the wire grid polarizer of claim 1 which is on an upper part, a lower part or both the upper part and the lower part of the liquid crystal panel.

16. A method of fabricating a wire grid polarizer, the method comprising:
forming a conductive wire pattern on a substrate, comprising:
forming a conductive wire pattern material in which an oxide layer is defined at an outer surface thereof, and
forming an oxidation resistant layer on the outer side surface of the conductive wire pattern material at which the oxide layer is defined,
wherein the oxide layer at the outer side surface of the conductive wire pattern material is not exposed outside the conductive wire pattern after the forming the conductive wire pattern.

17. The method of claim 16, wherein the forming of the oxidation resistant layer includes plasma-depositing and polymerizing fluorocarbon gas.

18. The method of claim 16, wherein the fluorocarbon gas comprises one or more selected from C₄F₈, CHF₃, CH₂F₂, CF₄, and C₂F₆.

19. The method of claim 16, further comprising forming a non-conductive pattern on the conductive wire pattern material in which the oxide layer is defined, such that the oxidation resistant layer and the non-conductive pattern cover the conductive wire pattern material outer side surface at which the oxide layer is defined and the oxide layer at the conductive wire pattern material outer side surface is not exposed outside the conductive wire pattern.
